(19) United States
(12) Patent Application Publication
(10) Pub. No.: US 2012/0304065 A1
(43) Pub. Date: Nov. 29, 2012

(54) DETERMINING INFORMATION ASSOCIATED WITH ONLINE VIDEOS

(75) Inventor: Jingzhu Cai, Hangzhou (CN)

(73) Assignee: ALIBABA GROUP HOLDING LIMITED, George Town (KY)

(21) Appl. No.: 13/479,089

(22) Filed: May 23, 2012

(30) Foreign Application Priority Data
May 25, 2011 (CN) 201110137535.X

(51) Int. Cl. G06F 3/01; G06F 3/048

(52) U.S. Cl. 715/719

(57) ABSTRACT

Determining information associated with a video is described herein, including: receiving a selection associated with a trigger point in a feature frame associated with a streaming video; and presenting a popup layer including content associated with the trigger point.

### CROSS REFERENCE TO OTHER APPLICATIONS

This application claims priority to People's Republic of China Patent Application No. 201110137535.X entitled AN ONLINE VIDEO-BASED DATA EXCHANGE METHOD AND DEVICE filed May 25, 2011 which is incorporated herein by reference for all purposes.

### FIELD OF THE INVENTION

The present application relates to the technical field of network data exchange. In particular, it relates to a technique of retrieving information associated with an online video.

### BACKGROUND OF THE INVENTION

E-commerce refers to a business model that has become a part of worldwide commercial trading activities. According to this model, buyers and sellers can engage in various commercial activities in open Internet network environments and carry out online consumer purchases, online transactions and online electronic payments, as well as various other business activities, trading activities, financial activities, and related integrated service activities, without ever needing to meet in person.

More and more, online shopping has become a mainstream consumer activity. Conventionally, online shopping entails that a user searches for products that he or she is interested in at a website and/or a search engine. The user can purchase products through electronic order forms at an online store including by first providing a method of online payment and then waiting to receive the products in the mail and/or through some other form of fulfillment process. As an example, online shopping at an e-commerce website may entail the following: 1) a user visits the e-commerce website (e.g., taobao.com) 2) the user selects the product (e.g., at the product profile webpage for that product) that he or she wishes to buy, submits a purchase request, and then completes the payment.

With the rapid development of online video technology, users may desire to obtain relevant product information on products featured in online videos that the users are streaming. The users may even be interested in purchasing such products. However, conventionally, a user may need to manually note down the products of interest that are shown in an online video and then independently search for the products at an e-commerce website and/or with a search engine based on the manually produced notes. But this technique is error prone and also tedious as the user may not be able to ascertain accurate descriptions of the products.

An existing technique to facilitate the user retrieval of product information associated with a streaming online video involves embedding web pages in the online video. For example, this technique may include the embedding of formatted video advertisements (with product information) into online videos featuring other content. The online videos and the video advertisements can have different formats. As a result, when such video advertisements are uploaded, it is necessary to convert the format of the embedded video advertisements to the format of the current online video in which the advertisements are embedded. For example, if the current online video is in an FLV format, but the video advertisement that needs to be embedded in the current online video is in a WMV format, then it is necessary to convert the video advertisement from the WMV format to the FLV format before uploading the video advertisement. When this technique is applied, a user who is viewing the current online video may click on a selectable element of the online video that is associated with the video advertisement or a selectable element of the video advertisement itself (e.g., the video advertisement may play during a break in the middle of the current online video), and a new webpage will be opened to display any product information and/or a different website associated with the selected video advertisement. However, embedding video advertisements into the online video may increase the transmission volume of streaming media data and therefore inefficiently use bandwidth, which may lead to data blockages and an increase in the number of interruptions in the playback of the online video. Furthermore, converting video advertisements into the appropriate format may undesirably consume human and material resources, but also take up a nontrivial amount of processing resources, either at the server and/or of a format-processing system. In addition, while video advertisements may display the product information corresponding to the user, it does not help the user complete the online shopping process quickly.

### BRIEF DESCRIPTION OF THE DRAWINGS

Various embodiments of the invention are disclosed in the following detailed description and the accompanying drawings.

FIG. 1 is a diagram showing an embodiment of a system for determining information associated with online videos.

FIG. 2A is a flow diagram showing an embodiment of a process for determining information associated with online videos.

FIG. 2B shows an example of a feature frame in a streaming online video showing a fashion show.

FIG. 2C shows an example of an online video with a popup layer presented over it.

FIG. 3 is a flow diagram showing an embodiment of a process for determining information associated with online videos.

FIG. 4 is a flow diagram showing an embodiment of a process of determining information associated with online videos.

FIG. 5 is a diagram showing an embodiment of a system for determining information associated with online videos.

FIG. 6 is a diagram showing an embodiment of a system for determining information associated with online videos.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining information associated with online videos is described herein. In an online video, one or more trigger points may be embedded in one or more feature frames of the video. In various embodiments, a “trigger point” refers to a selectable element of an online video that when selected, causes a display of information. In various embodiments, trigger points are placed on one or more particular areas (e.g., an image of a product that is shown/advertised/placed in the video) of one or more feature frames of the online video. In some embodiments, the trigger point is placed over the online video. In some embodiments, a trigger point is associated with metadata such as, for example, product information, keywords, searching conditions, and uniform information locators (URLs). In various embodiments, a “feature frame” refers to one or a series of frames of an online video that are embedded with one or more trigger points. During the stream of an online video, a user may make a selection (e.g., via a computer cursor) at one or more trigger points (e.g., associated with products shown in the video that the user is interested in) to receive more information based on the selected trigger points, including the further option to purchase one or more products that are associated with the selected trigger points. In this way, trigger points provide a technique of facilitating user interaction with the online videos to obtain information relevant to items that are shown in the online videos.

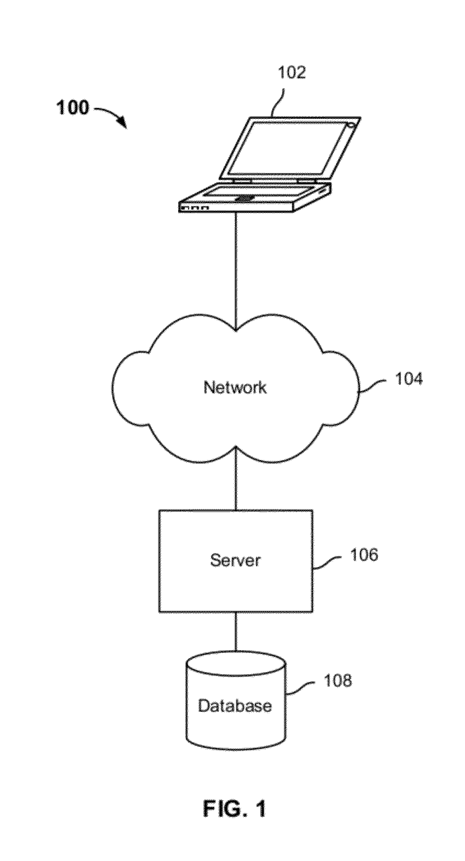

FIG. 1 is a diagram showing an embodiment of a system for determining information associated with online videos. In the example, system 100 includes client 102, network 104, server 106, and database 108. Network 104 may include high-speed data networks and/or telecommunication networks.

Client 102 is configured to communicate with server 106 over network 104. While client 102 is shown to be a laptop, other examples of client 102 include a desktop computer, a mobile device, a smartphone, a tablet device and/or any type of computing device. A user may use a web browser application at client 102 to stream online videos from one or more websites. In some embodiments, server 106 is configured to host at least one website at which online videos are streamed.

Server 106 is configured to facilitate user interaction with online videos. In some embodiments, server 106 is configured to determine information associated with products and/or other items of interest that are displayed/shown within online videos. In some embodiments, online videos for which trigger points are embedded at certain feature frames may be interacted with by a user via a computer mouse. For example, a trigger point may be embedded at a point and/or location of an online video associated with a product shown in the video such that for a user viewing the video (e.g., at client 102), the user may use the cursor to select the trigger point. Once the trigger point is selected, a popup layer (e.g., implemented using JavaScript) may be generated and presented over at least a portion of the video. Inside the popup layer may be displayed product information associated with a product shown in the video. For example, the product information determined to be included in the popup layer may be determined by processing a set of metadata (e.g., stored in database 108) associated with the selected trigger point. By embedding trigger points inside online videos and in particular, in association with products featured in the videos, a user's online shopping experience may be enhanced with the ability to learn more about the products simply by interacting with trigger points embedded near the products in at least some of the video frames in which they appear.

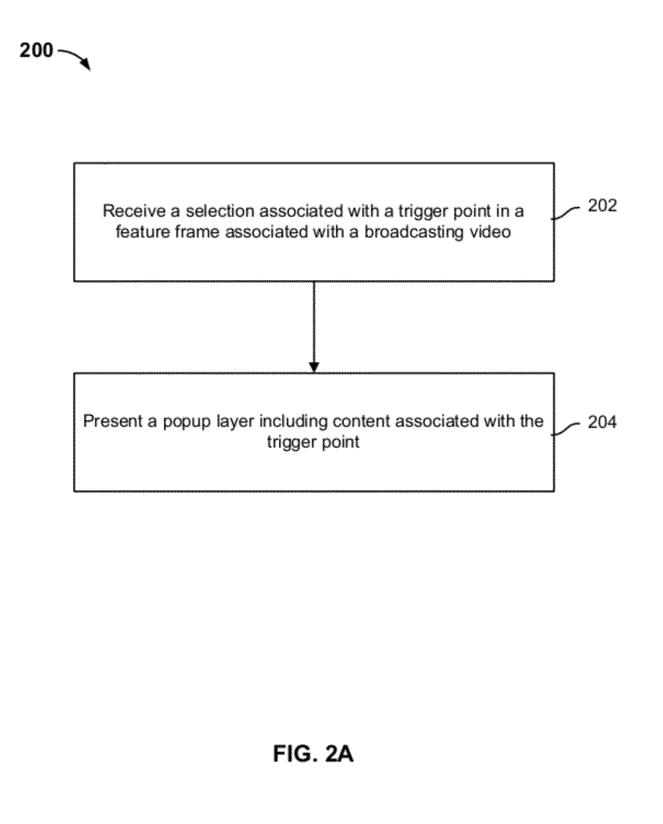

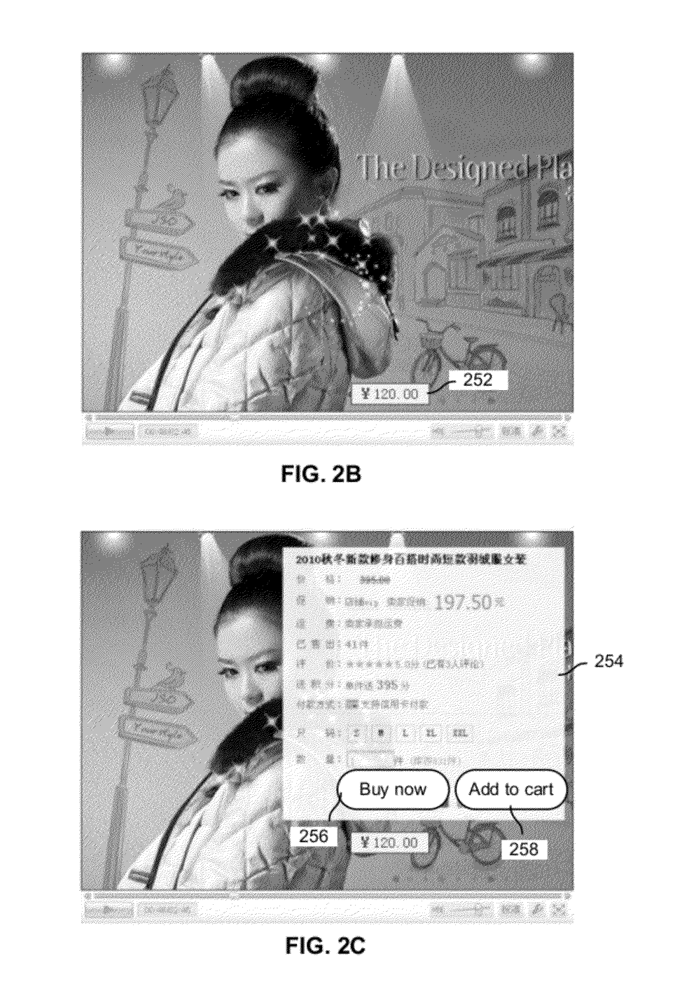

FIG. 2A is a flow diagram showing an embodiment of a process for determining information associated with online videos. In some embodiments, process 200 may be implemented at system 100.

At 202, a selection associated with a trigger point in a feature frame associated with a streaming video is received. In some embodiments, the online video is currently being streamed at a webpage. In some embodiments, the trigger point is an element implemented using logic and/or computer programming. In some embodiments, the trigger point may be embedded in one or more feature frames of the online video prior to it being made available for streaming at one or more client devices. For example, the trigger point may be associated with a particular image and/or portion of each feature frame. For example, the trigger point may be associated with a particular product that is shown in one or more frames of the video. In some embodiments, the trigger point is placed over the video. In some embodiments, a trigger point is embedded into a layer (e.g., a control layer) of the video. During the stream of the video, various frames will be shown. Those frames that are embedded with triggers points (feature features) may appear throughout the streaming of the video. In some embodiments, the trigger points that are embedded in the control layer are available for selection when a feature frame of the online video is being shown and are unavailable for selection when a feature frame of the online video is not being shown. When a feature frame is shown, a user viewing the video may have the opportunity to select one or more trigger points embedded in the feature frame. In some embodiments, the location and/or availability of a trigger point is denoted by a visual indicator. In some embodiments, the visual indicator that denotes the availability and/or location of a trigger point with respect to a feature frame of the online video is an icon. For example, such an icon may display a price tag associated with an item shown in the video. In some embodiments, the location and/or availability of a trigger point is invisible to the user until the user places a cursor over the general region of the trigger point.

In some embodiments, a selection is made with respect to a trigger point when a user places a cursor (e.g., using a computer mouse) over a portion of the feature frame that is associated with the trigger point. In some embodiments, placing the cursor over and/or around a feature frame is referred to as hovering the cursor over the feature frame. In this example, the user is not required to click on the trigger point to make the selection. In some embodiments, the user is required to click on the trigger point to make the selection.

The following in an example of making a selection associated with a trigger point: A method associated with invoking functions based on whether a cursor is placed over (i.e., hovering over) a designated element (e.g., trigger point) may be used to implement invoking functions with respect to a trigger point. For example, the onMouseOver( ) method in the JavaScript language may be such a method. In using the JavaScript onMouseOver( ) method, when a cursor is moved over a designated element, such as a trigger point, the action will trigger a designated first function and when the cursor moves away from the trigger point, the action will trigger a designated second function. For example, the first function invoked when the cursor is moved over the trigger point may cause a popup layer (e.g., a popup box of configured dimensions) to be presented over the video. For example, the popup layer may be implemented as a DIV popup layer, which may be a popup function implemented using Javascript and a DIV element that determines at least the dimensions of the popup layer (e.g., <div style=“position:absolute;width:[customized width];height:[customized height]”></div>). In some embodiments, tests can be performed to determine whether the cursor remains over the trigger point over time. As long as it is determined that the cursor still remains over the trigger point, the popup layer remains over the video. In some embodiments, the popup layer will remain over the online video even if the cursor is moved out of the region of the trigger point until a user selection is made to close the popup layer.

In some embodiments, in response to a selection being made with respect to a trigger point, the online video pauses. In some embodiments, in response to a selection being made with respect to a trigger point (e.g., a mouse moves over the trigger point), a message is sent to the server that hosts the online video to pause the stream. In some embodiments, the server that hosts video does not resume (un-pause) the stream of the online video until the selection is no longer being made (e.g., the mouse moves out of the region of the trigger point and/or out of the region of the online video and/or the displayed popup layer is closed).

At 204, a popup layer including content associated with the trigger point is presented. In some embodiments, in response to the selection of the trigger point, a popup layer appears over the video. In some embodiments, the size (width and height) and/or placement of the online video is obtained and used to determine the size and/or placement of the popup layer presented when the trigger point is selected based on one or more preset rules. In some embodiments, if desired, further display details may be configured for the popup layer, such as the background and/or other display attributes.

In some embodiments, preset metadata is associated with each trigger point such that once a trigger point is selected, the preset metadata associated with that trigger point is processed. In some embodiments, the preset metadata associated with a trigger point may include computer programming code and/or some other type of operations that indicate an action to be performed. For example, the preset metadata may indicate that certain information is to be displayed inside the popup layer such as text and/or pictures and/or links. For example, the preset metadata may indicate that a search is to be performed at a database and/or a search engine and that the information that matched the search is to be displayed inside the popup layer. In some embodiments, the content of a popup layer may be loaded using an iframe or jQuery's load( ) method.

FIGS. 2B and 2C are diagrams that illustrate an example of selecting a trigger point embedded in an online video. FIG. 2B shows an example of a feature frame in a streaming online video showing a fashion show. As shown in the example, the current frame in the video shows a jacket. A user watching the video may take an interest in this jacket featured in the video and desire to learn more about this product. To do so, the user may move his or her computer mouse cursor over icon 252, which is associated with a trigger point associated with the jacket. In response to the cursor selecting (e.g., being placed over or clicking on) the jacket trigger point, a popup layer associated with the jacket popup layer may be presented over the video. FIG. 2C shows an example of the online video with a popup layer presented over it. In response to the selection of the jacket trigger point, the online video is paused and popup layer 254 is presented over the video. As shown in the example, popup layer 254 displays product information associated with the jacket trigger point, such as the name of the jacket, the price of the jacket, consumer reviews of the jacket, and availability of the jacket at one or more online stores. In the example, the jacket is available for purchase and so there are two selectable elements, “Buy now” button 256 and “Add to cart” button 258, that are presented. If the user wishes to purchase the jacket, the user may select “Buy now” button 256 to be taken to an online transaction platform at a website (e.g., in a new frame) that sells the jacket or the user may select “Add to cart” button 258 to be taken to a website (e.g., in a new frame) at which the jacket product would be added to the website's shopping cart. In some embodiments, once the purchase transaction of the jacket is completed, the user is directed back to the paused video, which also resumes playing. In some embodiments, the paused video may also resume playing if the user closes the popup layer and/or moves the cursor out of the region of the jacket trigger point and/or online video.

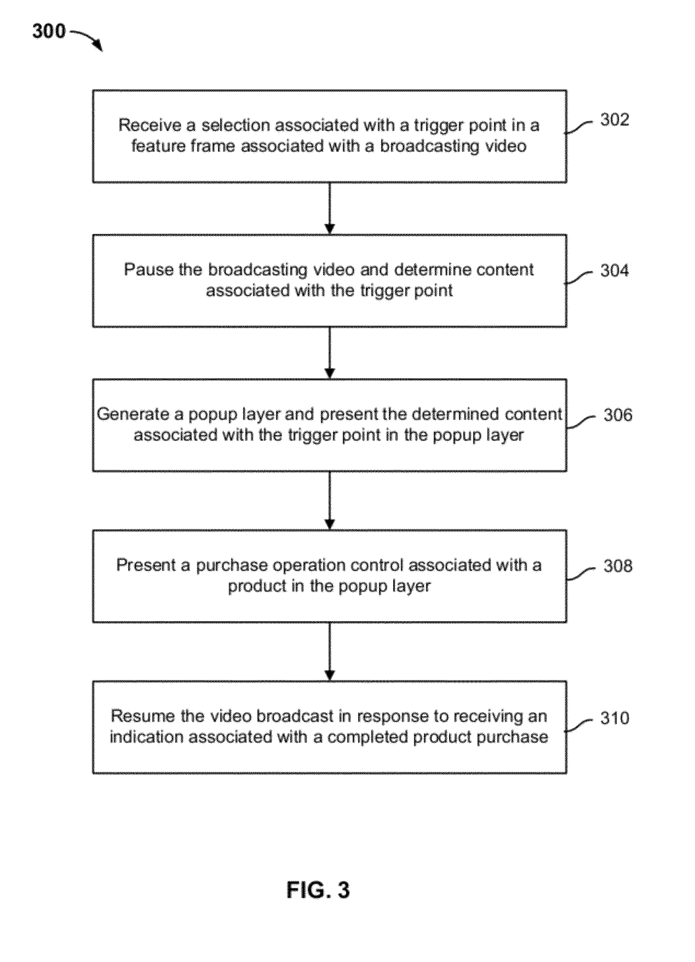

FIG. 3 is a flow diagram showing an embodiment of a process for determining information associated with online videos. In some embodiments, process 300 is implemented at system 100.

At 302, a selection associated with a trigger point in a feature frame associated with a streaming video is received. In some embodiments, and as described for 202 of process 200, a trigger point embedded in a feature frame may be selected when a cursor is placed over the image and/or a portion of the feature frame that is associated with the trigger point. In some embodiments, a trigger point embedded in a feature frame may be selected when a cursor, placed over the image and/or a portion of the feature frame that is associated with the trigger point, actually clicks on the trigger point. For example, the online video that is currently being streamed may feature at least one product. For example, prior to it being available for streaming, the video may be embedded with various trigger points for the products and/or other items/images of possible interest to the users at the frames in which the products and/or other items/images of possible interest to a user appear. In some embodiments, a trigger point is associated with each of at least some of the products and/or other items/images that appear in the video.

At 304, the streaming video is paused and content associated with the trigger point is determined. Subsequent to a selection of a trigger point, the stream of the online video is paused. Furthermore, the preset metadata for the selected trigger point is retrieved and processed.

In some embodiments, the preset metadata of the selected trigger point includes predetermined product information that is to be displayed. For example, if the trigger point were associated with a jacket shown in the video, in response to the selection of the trigger point, the preset metadata for the trigger point may be executed to display the set of predetermined product information such as the name, price, and links to online stores that sell the jacket.

In some embodiments, the preset metadata of the selected trigger point includes computer programming code that is used to search for relevant product information located in a given database. In some embodiments, the preset metadata may include computer programming code, an ID value of the relevant product information and a URL associated with a database. For example, if the trigger point were associated with a jacket shown in the video, in response to the selection of the trigger point, a JavaScript code included in the preset metadata may be executed to search for the relevant product information at the identified database. The search results (e.g., the matching product information found in the database) is then returned.

In some embodiments, the preset metadata of the selected trigger point includes computer code that is used to search for relevant product information at a database of product information associated with a company website identified by a particular URL. In some embodiments, the preset metadata may include computer programming code, a URL associated with a company website, and a database thereof. For example, if the trigger point were associated with a jacket shown in the video, in response to the selection of the trigger point, the preset metadata may be executed to search for the relevant product information at the database of the identified company website. The search results (e.g., the matching product information found in the database) are then returned.

In some embodiments, the preset metadata of the selected trigger point includes computer programming code that is used to generate one or more search conditions/queries and to conduct searches with the generated conditions/queries at one or more identified sources (e.g., databases, websites, search engines). For example, each of the sources may be identified by a URL. For example, if the trigger point were associated with a jacket shown in the video, in response to the selection of the trigger point, the preset metadata may be executed to generate search conditions/queries for the jacket to a database, a search engine, and/or a website. For example, an associated source of a selected trigger point may relate to the product database of a preset business-to-consumer (B2C) website. When the trigger point is selected, keywords and/or attributes (e.g., “2011 Chanel spring apparel”) of the selected trigger point and/or with the current feature frame where the trigger point was embedded are generated and a search is performed with the generated keywords/attributes at a database associated with the preset B2C website by first establishing a connection to the database and then by conducting a search using the generated keywords/attributes at the database. The search results (e.g., the matching product information found in the database) is then returned. In some embodiments, the search results are filtered with the screening conditions such that only those search results that match the conditions are returned and those that do not match the conditions are discarded.

In some embodiments, the preset metadata of the selected trigger point includes computer programming that is used to conduct a picture-based search for relevant product information at a particular source (e.g., a search engine). In some embodiments, the preset metadata may include computer programming code, a URL associated with a company website, and a database thereof. For example, if the trigger point were associated with a jacket shown in the video, in response to the selection of the trigger point, the preset metadata may be executed to use a picture of the jacket or the paused screen of the paused online video to conduct a picture search for the relevant product information at an identified search engine. The search results (e.g., the matching product information and/or pictures that are found in the database) are then returned. Any appropriate technique of picture-based searching may be used. For example, the picture of the jacket may serve as the query picture and a search is conducted for images that appear to be similar to the jacket picture based on one or more metrics of image processing.

At 306, a popup layer is generated and the determined content associated with the trigger point is presented in the popup layer. The content (e.g., predetermined and/or matching product information) determined by processing the preset metadata associated with the selected trigger point is displayed in a generated popup layer. In some embodiments, the popup layer is presented over at least a portion of the paused video.

Examples of product information may include one or more of the following: product name, product price, seller information, and/or purchase setting information. For example, the popup layer may display the following information: product name, product price, product specifications, dimensions, size, model number, an available quantity, and any other appropriate information. For example, if product information is to be displayed for only one product in the popup layer, then detailed information related to the product may be displayed, e.g., product name, product price, shipping fee, quantity sold, product rating, size, order quantity, etc. However, if product information is to be displayed for more than one product in the popup layer, then only the more important product-related information may be displayed, e.g., product name, product price, and seller information, for example, while the more detailed product information may be available for view upon a selection of the user.

At 308, a purchase operation control associated with a product is presented in the popup layer. In some embodiments, purchase operation controls associated with one or more products for which product information is displayed in the popup layer are also included in the popup layer. For example, purchase operation controls may include selections associated with “Buy now” and “Add to cart.” For example, one or both of the “Buy now” and “Add to cart” controls may be presented next to each piece of product information that is displayed in the popup layer. For example, if the user clicks on the “Buy now” selection presented at the popup layer, then a new frame may open to direct the user to a webpage associated with the checkout process of an online transaction platform (e.g., of an online store). For example, if the user clicks on the “Add to cart” selection presented at the popup layer, then a new frame may open to direct the user to a webpage associated with a shopping cart webpage of an online transaction platform (e.g., of an online store). In some embodiments, if the user proceeds with completing the purchase of the product, then the user may be guided back to the webpage associated with the paused online video.

At 310, in response to receiving an indication associated with a completed product purchase, the video stream is resumed. In some embodiments, subsequent to a successful purchase of a product at the webpage associated with the online transaction platform, the video streaming is resumed. In various embodiments, the video stream may resume even if a purchase is not completed if, for example, the user makes a selection to un-pause/resume the video stream or to close the popup layer.

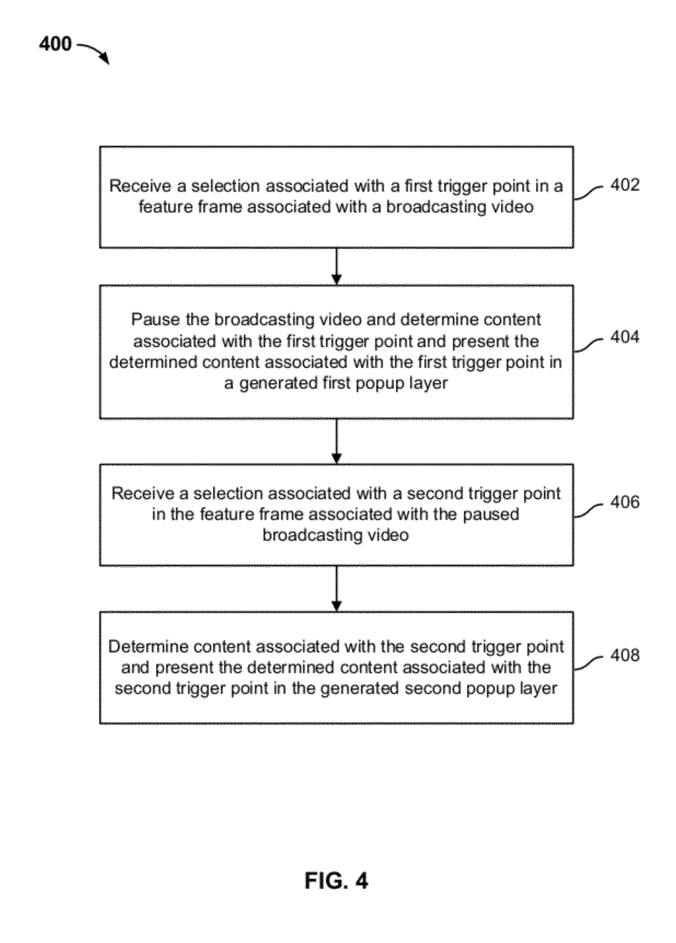

FIG. 4 is a flow diagram showing an embodiment of a process of determining information associated with online videos. In some embodiments, process 400 may be implemented at system 100.

Process 400 may be used when more than one trigger point on the same feature frame is selected.

At 402, a selection associated with a first trigger point in a feature frame associated with a streaming video is received.

At 404, the streaming video is paused and content associated with the first trigger point is determined and the determined content associated with the first trigger point is presented in a generated first popup layer. Using the same techniques as described above, the preset metadata associated with the first trigger point may be processed to present product information in a popup layer generated and presented over at least a portion of the video.

At 406, a selection associated with a second trigger point in the feature frame associated with the paused streaming video is received. In process 400, a second trigger point is selected at the feature frame of the online video that has been paused since the previously selected first trigger point. During and subsequent to the second trigger point being selected, the video remains paused.

At 408, content associated with the second trigger point is determined and the determined content associated with the second trigger point is presented in a generated second popup layer.

In some embodiments, in response to the selection of the second trigger point, the first popup layer on the currently paused video is closed and the generated second popup layer is presented over at least a portion of the paused video. In some embodiments, the appearance of the second popup layer is determined based at least in part on the size (width and height) and/or placement of the online video and/or the size of the first popup layer based on one or more preset rules.

In some other embodiments, the first popup layer is not closed and both the first and second popup layers are presented over at least a portion of the paused video. In the event that the first popup layer is not closed and appears with the second popup layer on at least a portion of the paused video, one of the first and second popup layers may be presented over at least a portion of the other or not at all.

In some embodiments, the content associated with the second trigger point may be determined in a manner similar to how preset metadata is determined for the first trigger point. Depending on the preset metadata associated with the second trigger point, the preset content may dictate to present some predetermined product information or to search for product information at an identified database and/or search engine and/or website. The determined content (e.g., product information) is then presented in the second popup layer.

For example, if the online video included a fashion show, then the first trigger point may be associated with a suit jacket that is featured in the fashion show video and the second trigger point may be associated with a pair of suit slacks. If a user who is viewing the online video becomes interested in both the jacket and slacks of the suit, then the user may move the cursor over the jacket, which pauses the video and also triggers the first trigger point to determine content (e.g., product information of the jacket) associated with the first trigger point and display it in a first popup layer. While the video remains paused, the user may also move the cursor over the slacks, which triggers the second trigger point. Depending on the configuration, the first popup layer may either remain open or closed. Then content associated with the second trigger point (e.g., product information of the slacks) is determined and displayed in a second popup layer.

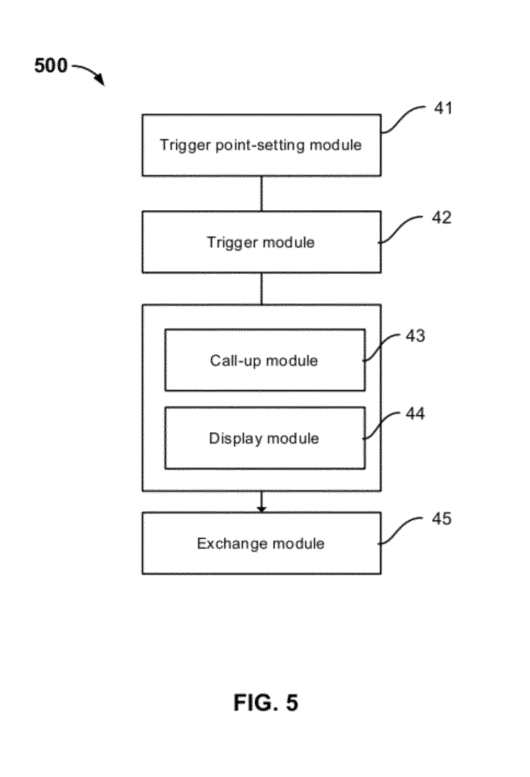

FIG. 5 is a diagram showing an embodiment of a system for determining information associated with online videos.

The modules and sub-modules can be implemented as software components executing on one or more processors, as hardware such as programmable logic devices and/or Application Specific Integrated Circuits designed to perform certain functions, or a combination thereof. In some embodiments, the modules and sub-modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules and sub-modules may be implemented on a single device or distributed across multiple devices.

System 500 includes trigger point-setting module 41, trigger module 42, call-up module 43, display module 44, and exchange module 45. Trigger point-setting module 41 is configured to embed in one or more feature frames in an online video a trigger point used to determine specific (e.g., product) information.

Trigger module 42 is configured to communicate with call-up module 43 and display module 44 in response to receiving a selection associated with the selected trigger point embedded in the feature frame during a stream of the online video.

Call-up module 43 is configured to determine the content associated with the selected trigger point based at least in part on processing preset metadata associated with the trigger point.

In some embodiments, call-up module 43 further includes (not shown):

A related product information-acquiring module is configured to retrieve product information corresponding to the selected trigger point based on the associated preset metadata.

A search condition-generating sub-module is configured to generate search conditions according to the preset metadata associated with the trigger point.

A database search sub-module is configured to use the generated search conditions to connect to a product database, to conduct a search at the database, and to obtain product information matching the search conditions.

An Internet search sub-module is configured to use pictures included in the preset metadata associated with the trigger point in the feature frame to conduct a picture-matching search on the Internet and to obtain search results.

A screening sub-module is configured to extract product information that matches the screening conditions from the search results.

A shopping exchange sub-module is configured to direct to a webpage associated with a product exchange platform corresponding to the selected purchase operation control so as to complete an online purchase transaction.

Display module 44 is configured to generate a popup layer and to display the determined content associated with the selected trigger point. In some embodiments, display module 44 is further configured to present a purchase operation control associated with product in the popup layer.

Exchange module 45 is configured to facilitate a purchase transaction associated with completing an online transaction with respect to a product. For example, in response to a user selection of the purchase operation control (e.g., a “Buy now” button or an “Add to cart” button) presented inside the popup layer, the process to complete an online purchase is performed at a webpage.

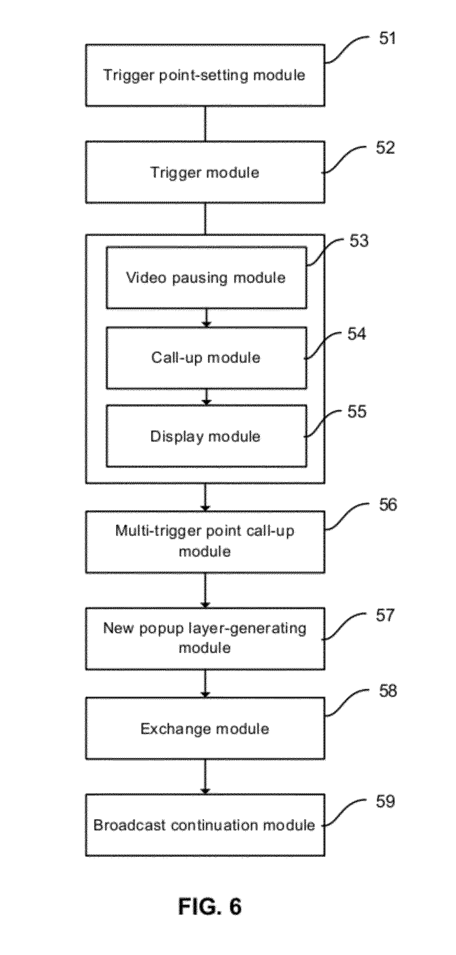

FIG. 6 is a diagram showing an embodiment of a system for determining information associated with online videos.

Trigger point-setting module 51 is configured to set in a feature frame of an online video a first trigger point used to determine specific (e.g., product) information.

Trigger module 52 is configured to communicate with video pausing module 53, call-up module 54, and display module 55 in response to a selection of the first trigger point during a stream of the online video.

Video pausing module 53 is configured to pause the current stream of the online video.

Call-up module 54 is configured to determine the content corresponding to the selected first trigger point.

Display module 55 is configured to generate a first popup layer over at least a portion of the currently paused video and to display the determined content in the first popup layer.

Multi-trigger point call-up module 56 is configured to determine when a second trigger point in the feature frame is selected, then to determine the content associated with the second trigger point.

New popup layer-generating module 57 is configured to generate a second popup layer to be presented over at least a portion of the paused video stream page and to display at least the determined content associated with the second trigger point in the second popup layer.

Exchange module 58 is configured to facilitate a purchase transaction associated with completing an online transaction with respect to a product. For example, in response to a user selection of the purchase operation control (e.g., a “Buy now” button or an “Add to cart” button) presented at either and/or both of the first and second popup layers, the process to complete an online purchase is performed at a webpage.

Stream continuation module 59 is configured to resume (e.g., un-pause) the currently paused video stream subsequent to the completion of the online purchase transaction.

The present application can be used in many general purpose or specialized computer system environments or configurations. For example: personal computers, servers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipment above, and so forth.

The present application can be described in the general context of computer executable commands executed by a computer, such as a program module. Generally, program modules include routines, programs, objects, components, data structures, etc. to execute specific tasks or achieve specific abstract data types. The present application can also be carried out in distributed computing environments. In such distributed computing environments, tasks are executed by remote processing equipment connected via communication networks. In distributed computing environments, program modules can be located on storage media at local or remote computers that include storage equipment.

Data analysis methods, systems and servers provided by the present application have been described in detail above. This document has employed specific embodiments to expound the principles and forms of implementation of the present application. The above embodiment explanations are only meant to aid comprehension of the methods of the present application and of its core concepts. Moreover, a person with general skill in the art would, on the basis of the concepts of the present application, be able to make modifications to specific applications and to the scope of applications. To summarize the above, the contents of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for determining information associated with a streaming video, comprising:
a processor configured to:
receive a selection associated with a trigger point in a feature frame associated with the streamed video, wherein the trigger point comprises a selectable element that in response to being selected, is configured to cause information to be displayed over the video, wherein the featured frame comprises a frame in the video associated with at least one trigger point; and
present a popup layer including content associated with the trigger point; and
a memory coupled to the processor and configured to provide the processor with instructions.

2. The system of claim 1, wherein the selection is received in response to a cursor being placed over a region of the feature frame associated with the trigger point.

3. The system of claim 1, wherein the processor is further configured to pause the streaming video in response to the selection.

4. The system of claim 1, wherein the processor is further configured to determine the content associated with the trigger point based at least in part on processing a set of preset metadata associated with the trigger point.

5. The system of claim 4, wherein processing the set of preset metadata includes presenting a set of predetermined product information.

6. The system of claim 4, wherein processing the set of preset metadata includes searching for product information at a database.

7. The system of claim 4, wherein processing the set of preset metadata includes searching for product information at a website.

8. The system of claim 4, wherein processing the set of preset metadata includes generating a search query and searching with the generated query at an identified source.

9. The system of claim 1, wherein the popup layer comprises a DIV popup layer.

10. The system of claim 1, wherein the processor is further configured to present a purchase operation control associated with a product in the popup layer.

11. The system of claim 10, wherein the processor is further configured to receive an indication associated with a selection of the purchase operation control and to present a webpage associated with an online transaction platform.

12. The system of claim 10, wherein the processor is further configured to receive an indication associated with a completed product purchase and in response, to resume the video stream.

13. The system of claim 1, wherein the trigger point comprises a first trigger point and the popup layer comprises a first popup layer, wherein the processor is further configured to receive a selection associated with a second trigger point and to present content determined for the second trigger point in a second popup layer.

14. The system of claim 13, wherein the content determined for the second trigger point is determined based at least in part on processing a set of preset metadata associated with the second trigger point.

15. A method for determining information associated with a streaming video, comprising:
receiving a selection associated with a trigger point in a feature frame associated with the streamed video, wherein the trigger point comprises a selectable element that in response to being selected, is configured to cause information to be displayed over the video, wherein the featured frame comprises a frame in the video associated with at least one trigger point; and
presenting a popup layer including content associated with the trigger point.

16. The method of claim 15, wherein the selection is received in response to a cursor being placed over a region of the feature frame associated with the trigger point.

17. The method of claim 15, further comprising determining the content associated with the trigger point based at least in part on processing a set of preset metadata associated with the trigger point.

18. The method of claim 17, wherein processing the set of preset metadata includes presenting a set of predetermined product information.

19. The method of claim 17, wherein processing the set of preset metadata includes searching for product information at a database.

20. The method of claim 17, wherein processing the set of preset metadata includes searching for product information at a website.

21. The method of claim 17, wherein processing the set of preset metadata includes generating a search query and searching with the generated query at an identified source.

22. The method of claim 15, wherein the trigger point comprises a first trigger point and the popup layer comprises a first popup layer, wherein the processor is further configured to receive a selection associated with a second trigger point and to present content determined for the second trigger point in a second popup layer.

23. The method of claim 22, wherein the content determined for the second trigger point is determined based at least in part on processing a set of preset metadata associated with the second trigger point.

24. A computer program product for determining information associated with a streaming video, the computer program product being embodied in a computer readable storage medium and comprising computer instructions for:
receiving a selection associated with a trigger point in a feature frame associated with the streamed video, wherein the trigger point comprises a selectable element that in response to being selected, is configured to cause information to be displayed over the video, wherein the featured frame comprises a frame in the video associated with at least one trigger point; and
presenting a popup layer including content associated with the trigger point.
